(19) United States
(12) Patent Application Publication
(10) Pub. No.: US 2005/0031516 A1
(43) Pub. Date: Feb. 10, 2005

(54) Method and plant for continuous depollution of earths or sludge

(76) Inventors: Eric Marty, Lyon (FR); Pascal Van Hulle, Gif Sur Yvette (FR)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/891,074

(22) Filed: Jul. 15, 2004

(30) Foreign Application Priority Data
Jul. 15, 2003 (FR) 03/08.636

(51) Int. Cl. B01D 53/72; B01J 8/00; C10G 35/00

(52) U.S. Cl. 423/245.3; 422/209

(57) ABSTRACT

The invention relates to a method and to a plant intended for continuous depollution of a solid feed comprising essentially earths or sludge, as well as organic pollutants. The method comprises the following stages: a) passing a gas stream brought to a temperature higher than the desorption temperature of water through a solid feed layer arranged in several contacting zones arranged in series, so as to recover a depolluted solid feed and a gaseous effluent comprising pollutants, b) separating the gaseous effluent comprising pollutants from the depolluted solid feed, c) sending said gaseous effluent to an oxidation zone so as to oxidize the pollutants and to recover an oxidized gaseous effluent, d) sending a portion of the oxidized gaseous effluent to a treating unit and introducing another portion of the oxidized gaseous effluent as gas stream in stage a).

### FIELD OF THE INVENTION

The present invention relates to a method and to a device for treating earths or sludge contaminated by organic matter. These contaminated earths or sludge can come from former industrial sites, drilling sites for example, or from former gas plants.

One application of the invention is the remediation of earths or sludge contaminated by hydrocarbon effluents that may contain chlorinated products or other pollutants such as dioxins for example.

### BACKGROUND OF THE INVENTION

American patent U.S. Pat. No. 5,337,684 describes a method and a device for depolluting materials likely to flow, such as liquids, sludge or earths. In the device described in this patent, the contaminated materials are heated by direct contact with a heating fluid. The heat released with the vaporized pollutants is then recovered and re-used in the various heating means.

One of the technical problems posed by such a method is the recovery by desorption of a large amount of pollutants when an earth-based or sludge-based feed is contacted with a hot gas stream. Furthermore, transfer of the pollutants between the solid feed and the gas stream is not optimized. Besides, the energy consumption and the discharge of pollutants to the atmosphere are increased during the sequence of stages.

The present invention aims to overcome the aforementioned drawbacks by means of a method allowing to reconcile an efficient depollution of the contaminated earths or sludge with selective pollutant recovery and good optimization of the energy efficiencies.

### SUMMARY OF THE INVENTION

The present invention thus relates to a method intended for continuous depollution of a solid feed essentially comprising earths and sludge, as well as organic pollutants, wherein the following stages are carried out:
a) passing a gas stream brought to a temperature higher than the desorption temperature of water through a solid feed layer arranged in several contacting zones arranged in series, so as to recover a depolluted solid feed and a gaseous effluent comprising pollutants,
b) separating the gaseous effluent comprising pollutants from the depolluted solid feed,
c) sending said gaseous effluent to an oxidation zone so as to oxidize the pollutants and to recover an oxidized gaseous effluent,
d) sending a portion of the oxidized gaseous effluent to a treating unit and introducing another portion of the oxidized gaseous effluent as gas stream into the contacting zone of stage a).

Preferably, during stage a), the velocity at which the gas stream is passed through the solid feed layer can be lower than the minimum rate of fluidization of said solid feed.

The velocity of the gas stream through the solid feed layer can be less than 1 m/s, preferably less than 0.5 m/s and more preferably less than 0.25 m/s.

The gas stream passed in stage a) can have a water content higher than 10% by volume, preferably higher than 15% by weight.

Advantageously, stage a) of the method according to the invention can be carried out at a temperature ranging from 500 to 1200° C., preferably from 700 to 1000° C., and more preferably from 800 to 900° C.

Preferably, at least a portion of the gas stream flowing through the solid feed layer can have an oxygen content preferably ranging from 2.5 to 15%, more preferably from 5 to 10% by volume.

A makeup gas stream containing oxygen can be introduced during stage a).

A makeup gas stream containing oxygen can therefore be introduced in the gas stream used in stage a) and/or with the gas stream used in stage a).

A makeup gas stream containing oxygen can also be introduced during stage c).

A makeup gas stream containing oxygen can be introduced in the oxidation zone for carrying out stage c) and/or in the gaseous effluent of stage b) prior to introduction in the oxidation zone of stage c).

The invention also relates to a plant intended for continuous depollution of a solid feed. This plant comprises
at least one hot gas stream supply means and at least one solid feed supply means,
a device for contacting the solid feed with the hot gas stream in several contacting zones arranged in series and comprising means for forming a solid feed layer and means allowing the gas stream to be passed through the solid feed layer thus formed,
separation means comprising a depolluted solid feed discharge means and discharge means for a gaseous effluent resulting from passage of the gas stream through the solid feed layer,
an oxidation means comprising precursor means for an oxidation reaction and an oxidized gaseous effluent discharge means,
a supply means for a treating unit intended for cleaning the oxidized gaseous effluent and a recycling means connected to the gas stream supply means.

The device for contacting the solid feed with the gas stream can comprise:
a drum provided with orifices and mounted rotating about its longitudinal axis, said drum comprising means allowing a feed layer flow to be obtained in said drum, and
an enclosure housing the drum, connected to at least one gas stream supply means and comprising means allowing the gas stream to be passed through said orifices.

The means allowing the gas stream to be passed through the orifices in the lower part of the drum can comprise gas stream distribution means allowing to pass distinct fractions of said stream into different contacting zones defined along the longitudinal axis of the drum.

Advantageously, a supply means intended for a makeup gas stream containing oxygen can be connected to the gas stream supply means.

This supply means intended for a makeup gas stream containing oxygen can be directly connected to the enclosure.

A supply means intended for a makeup gas stream containing oxygen can be connected to the oxidation means.

A supply means intended for a makeup gas stream containing oxygen can be connected to the discharge means intended for a gaseous effluent resulting from passage of the gas stream through the solid feed layer.

### BRIEF DESCRIPTION OF THE FIGURE

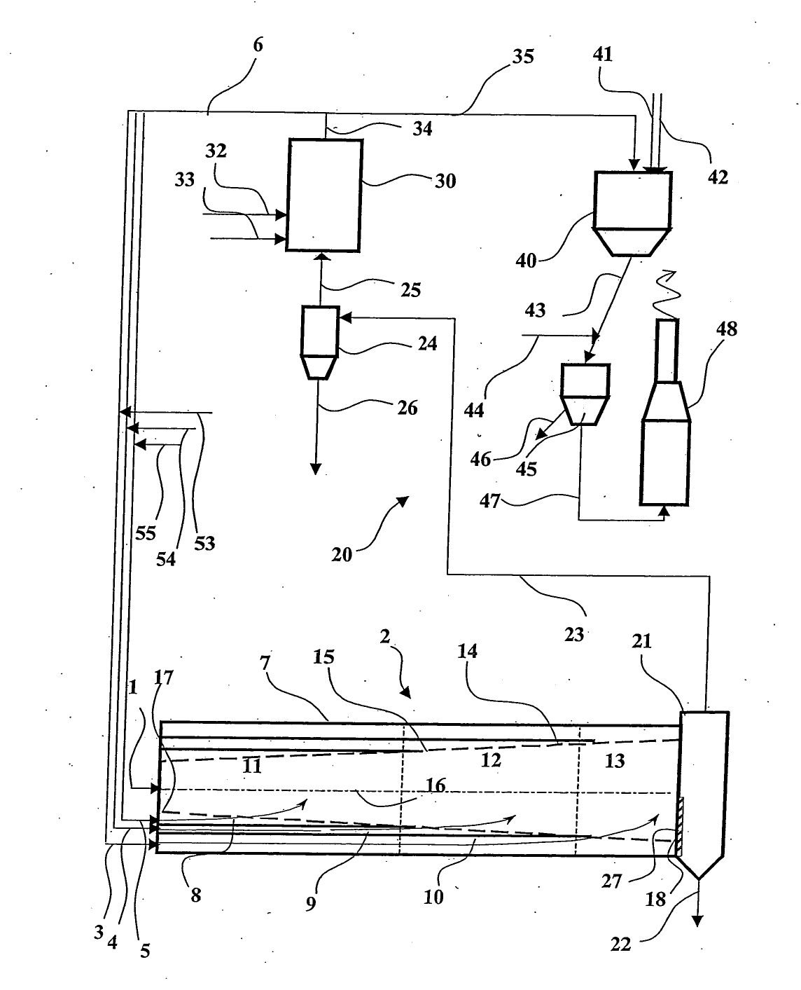

Other features and advantages of the invention will be clear from reading the description hereafter of an embodiment of the method according to the invention as illustrated in FIG. 1. This embodiment is given by way of example and has no limitative character. This illustration of the method according to the invention does not comprise all of the components required to implement it. Only the elements necessary for comprehension of the invention are shown, and the man skilled in the art will be able to complete this representation in order to implement the invention.

### DETAILED DESCRIPTION

The plant comprises a solid feed supply means 1 at the inlet of a “roto-louvre” type rotary oven 2, an oven that is better described, by way of example, in “Chemical Engineering Handbook”, 4^{th} Edition, pp.20-29.

This solid feed is typically an earth contaminated by at least organic matter. This feed conventionally comprises:
a matrix such as, for example, clay, sand, that can comprise mineral carbon and/or tars,
volatile, semivolatile and/or heavy organic pollutants such as, for example, gasoline, fuel oil, oil and/or polycyclic aromatic hydrocarbons,
water, and
possibly non-organic pollutants such as metals, for example iron and/or mercury.

The solid feed can comprise up to 15%, conventionally around 10% by weight of organic pollutants and around 20% by weight of water in relation to the matrix.

If the water content of the solid feed is higher than 20% by weight, drying of the solid feed can be carried out by means of conventional techniques known to the man skilled in the art, in order to bring this content down to about 20% by weight, prior to feeding it into the oven.

Oven 2 is supplied through three lines 3, 4, 5 with fractions of a hot gas stream delivered by a line 6.

Each line is provided with a makeup gas stream supply line, 53, 54, 55 respectively, and this makeup gas stream can comprise water and/or oxygen. Preferably, line 54 provided for supply line 4 allows a makeup gas stream comprising oxygen to flow into the gaseous effluent circulating in line 4.

The makeup gas stream generally has an oxygen content and/or a water content allowing to replace the oxygen consumed by oxidation or by purge.

Oven 2 comprises an enclosure 7 equipped with separate means 8, 9 and 10 allowing to distribute the gas stream fractions in three zones 11, 12 and 13 for contacting the feed and the gas stream fractions. These means are respectively connected to supply lines 3, 4 and 5 by any known means. Thus, line 5 supplies, through distribution means 8, a first contacting zone 11 located at the oven inlet, line 4 supplies, through distribution means 9, a second zone 12 located approximately in the middle of the oven and line 3 supplies, through distribution means 10, contacting zone 3 located at the oven outlet.

Each one of these separate means can comprise heating means and/or a makeup gas stream supply line as described above.

The oven comprises a drum 14 provided with orifices 15 and mounted rotating about its longitudinal axis 16, whose lower part is inclined so as to obtain gravity flow of a solid feed layer (not shown) between an upper end 17 of drum 14 connected to supply means 1 and a lower end 18 of this drum 14.

The drum can also be of cylindrical shape or preferably, as described, be truncated-cone-shaped. In the latter case, the solid feed layer flow can advantageously occur from the end having the smaller cross-section to the end having the larger cross-section.

The gas stream fractions carried by lines 3, 4 and 5 flow through the solid feed layer (not shown) formed along the lower part of drum 14 in contacting zones 11, 12 and 13.

The height of the solid feed layer in drum 14 can be controlled by means of an adjustable-height obstacle 27 mounted on lower end 18 of drum 14.

This solid feed layer can have a relative thickness variation below 50%, preferably below 30% and more preferably below 10%.

Lower end 18 of drum 14 is connected to a separation means 20 comprising a collector 21 provided with a means 22 for discharge of the solid feed and a discharge line 23 for a gaseous effluent. The separation means further comprises a cyclone 24 connected to line 23 and wherein the gaseous effluent resulting from passage of the gas stream through the layer of said solid feed circulates. This cyclone 24 discharges a gas phase through discharge line 25 and a solid phase through a line 26, and said line 26 can be connected to means 22 for discharge of the depolluted solid feed. The depolluted solid feed can be subjected to water quenching (not shown). In the embodiment shown, separation means 20 thus consists, on the one hand, of collector 21 provided with its depolluted solid feed discharge means 22 and with line 23 for discharge of the gaseous effluent resulting from passage of the gas stream through the solid feed layer and, on the other hand, of cyclone 24 with gaseous effluent supply line 23, gas phase discharge line 25 and solid phase discharge line 26.

Gas phase discharge line 25 is connected to an oxidation enclosure which is, in the example described, a combustion chamber, for example an oven, and which comprises precursor means for an oxidation reaction, such as a burner (not shown) equipped with fuel 32 and air 33 supply lines.

The oxidized gaseous effluent from combustion chamber 30 is discharged through a line 34. From this discharge line, a portion of this oxidized gaseous effluent is recycled to rotary oven 2 through line 6 and lines 3, 4, 5. The other portion is sent through a line 35 to a treating unit.

Preferably, one or the other or both of recycling line 6 and line 35 supplying the oxidized gaseous effluent treating unit are equipped with control valves connected to a device allowing the flow to be controlled in one or the other of these lines.

The treating unit comprises a treating chamber 40 where the oxidized gaseous effluent portion supplied through line 35 is cooled by quenching in water. The water is fed into chamber 40 through a line 41. Soda is also sent to chamber 40 by means of a line 42 connected to said chamber. The gaseous effluent thus cooled is discharged through a discharge line 43 connected to a filtration device 45. A line 44 allows additives such as lime, bicarbonate and/or activated charcoal to be injected into the cooled gaseous effluent in order to collect possible metals or other pollutants.

Filtration device 45 allows to recover in a line 46 the additives injected into line 44, as well as possible suspended particles. The filtered effluent is discharged through line 47 and sent to a chimney 48 allowing the oxidized gaseous effluent thus cleaned to be discharged to the atmosphere.

During operation, the solid feed is introduced at the inlet of the rotary oven through line 1 and the three contacting zones 11, 12, 13 of this oven are supplied with the hot gas stream fractions circulating in lines 3, 4, 5 and distribution means 8, 9, 10.

In this stage of the method, the solid feed is placed in the oven in form of a layer and a continuous flow of the solid feed layer is generally carried out. Contacting the solid feed with the gas stream fractions consists in passing this gas stream through the solid feed layer, this contacting operation can be listed among the contacting methods using percolation of a gas through a solid.

One generally tries to obtain a solid feed layer having a thickness homogeneously distributed over the contact surface. What is referred to as the contact surface is the surface covered with the solid feed layer through which the gas stream is passed. One thus tries to prevent any privileged passage of the gas stream through a particular zone of the contact surface so as to provide homogeneous contact of the gas stream with the solid feed.

The means for forming a solid feed layer can be any means known to the man skilled in the art. It is for example possible to use a means for pouring the solid feed onto an inclined support, through which the gas stream is injected.

The means for forming the solid feed layer is generally associated with a means for establishing a flow of this layer. This flow can be obtained by any means known to the man skilled in the art. This flow can for example be obtained by means of a mobile support such as an assembly conveyor comprising orifices allowing passage of the gas stream through the solid feed layer formed on said support. The solid feed layer flow can also be obtained by gravity by means of an inclined support such as drum 14 described in connection with FIG. 1, and this flow can possibly be facilitated by motions of the support.

Preferably, during this contacting stage, the velocity at which the gas stream is passed through the solid feed layer is lower than the minimum rate of fluidization of said solid feed. What is referred to as the minimum rate of fluidization is the minimum rate of the gas stream from which a fluidized solid feed bed is established. This minimum rate of fluidization generally depends on the characteristics of the solid feed and of the gas stream. Thus, the gas stream is passed through the solid feed layer with a sufficiently reduced velocity to limit entrainment of the solid feed with the gas stream.

Preferably, the velocity of the gas stream through the solid feed layer is less than 1 m/s, preferably less than 0.5 m/s and more preferably less than 0.25 m/s.

The gas stream generally comprises an inert gas that can be selected from the group consisting of nitrogen or carbon dioxide.

In some cases, the gas stream can advantageously comprise water injected through lines 53, 54, 55 into lines 3, 4, 5. By making use of the flow rate and of the water content of the gas stream, a compromise can be reached between the need to limit entrainment of the solid feed by said gas stream and the need to maximize the thermal transfer between said stream and said feed. The water content of the gas stream can generally range from 0 to 20% by weight. Preferably, the gas stream has a water content higher than 10% by volume, preferably higher than 15% by weight.

This stage of the method can be carried out at a pressure close to atmospheric pressure. In order to prevent any leak problems towards the outside of the oven enclosure, a negative relative pressure that can reach −2000 Pa can be preferably established.

Contacting the solid feed with the gas stream can be carried out in one or more contacting zones arranged in series or in parallel, at least one of said zones using a fraction of the gas stream.

As shown in the figure, a continuous flow of a solid feed layer is established through three contacting zones 11, 12, 13 arranged in series.

The residence time of the solid feed in the contacting zones with the gas stream can range from 10 minutes to 5 hours, preferably from 20 minutes to 3 hours, and more preferably from 30 minutes to 1 hour.

After flowing through the solid feed layer, the gas stream generally comprises organic pollutants. These pollutants can, in contact with the oxygen present in the gas stream, be a source of ignition or of explosion.

Advantageously, this contacting allows the presence of oxygen in the gas stream with a ratio between the volume of oxygen and the volume of volatile pollutants in the gas stream that can reach one third of the ratio between the theoretical volume of oxygen for oxidizing all of the volatile pollutants and the volume of said volatile pollutants.

Contacting is carried out with a gas stream temperature higher than the water desorption temperature, preferably at a temperature ranging from 500 to 1200° C., more preferably from 700 to 1000° C. and most preferably from 800 to 900° C. In this case, the gas stream flowing through the solid feed layer can have any oxygen content within the ignition limits defined above. This particular mode of the invention allows to treat organic pollutants which can, for the most part, be eliminated by pyrolysis. In this particular case, a single contacting zone can be sufficient.

In at least one contacting zone, a makeup gas stream can be injected directly or, if need be, mixed, by means of lines 53, 54, 55, with the gas stream fraction used. This makeup gas stream can comprise water and/or oxygen. Furthermore, the makeup gas stream or the gas stream fraction with which it is mixed can be heated beforehand.

Advantageously, at least one of the gas stream fractions flowing through the solid feed layer has an oxygen content up to 20%, preferably ranging from 2.5 to 15%, more preferably from 5 to 10% by volume.

This allows to treat pollutants that cannot, for the most part, be eliminated by pyrolysis.

In first contacting zone 11, drying can be carried out by bringing a first fraction of the gas stream to a temperature ranging from 500 to 1200° C., preferably from 700 to 1000° C. and more preferably from 800 to 900° C. The oxygen content can be any content, within the ignition limits defined above.

In second contacting zone 12, oxidation can be carried out by mixing with the gas stream circulating in line 4 a makeup gas stream comprising oxygen and circulating in line 54 so as to obtain a gas stream having an oxygen content ranging between 0 and 20%, preferably between 2.5 and 15%, more preferably between 5 and 10% by volume. The temperature in this second contacting zone can be less than 500° C., preferably less than 300° C., more preferably less than 100° C., for example in the region of the ambient temperature.

In third contacting zone 13, cooling of the solid feed can be carried out using a gas stream in the region of the ambient temperature. In this third zone, the oxygen content can be any content, within the ignition limits defined above. Air at ambient temperature is preferably used in this third zone.

After flowing through the oven, the treated feed is discharged to the outlet of oven 2 so as to separate the gaseous effluents and the solid effluents by separation means 20. During this separation stage, the gaseous effluent comprising the pollutants from the solid feed and the solid feed are first separated in collector 21, then the gaseous effluent from the collector and the solid particles it carried are separated by means of cyclone 24. This separation stage thus allows to recover through line 26 the solid feed dust present in the gaseous effluent.

At the end of this stage, a gaseous effluent that can comprise up to 30% by weight of water, volatile organic pollutants, organic pollutant oxidation products and inert compounds is recovered.

The proportion of volatile organic pollutants in the gaseous effluent is generally less than 1% by volume. The fact that a high dilution of the organic pollutants in the gaseous effluent can be obtained advantageously allows to treat solid feeds whose initial pollutant content is high, i.e. a pollutant content that can reach 15% by weight.

The solid feed thus depolluted has a purity level higher than 95% by weight, preferably higher than 98% by weight and more preferably higher than 99% by weight.

This depolluted solid feed can be advantageously subjected thereafter to a contacting treatment with water.

The gaseous effluent carried by line 25 is then sent to combustion chamber 30 where it is oxidized.

During this stage, the gaseous effluent is sent to an oxidation zone consisting of chamber 30 so as to oxidize the pollutants and an oxidized gaseous effluent is recovered. This oxidation can be carried out by any means known to the man skilled in the art, such as combustion or catalytic oxidation.

Preferably, oxidation by combustion is carried out in a combustion 30 or postcombustion chamber, by means of a burner supplied with fuel through line 32 and with oxidizer through line 33. The residence time of the fumes produced in the combustion chamber is generally higher than two seconds. The temperature at the combustion chamber outlet is then higher than 800° C., preferably higher than 900° C.

At the combustion chamber outlet, the oxidized gaseous effluent is carried by line 34. From this line, a portion of the oxidized gaseous effluent is sent through line 35 to a treating unit 40 for treating said portion. What is referred to as treating generally means eliminating certain compounds prior to sending this portion of the oxidized gaseous effluent to the atmosphere.

During this treating stage, this portion of the oxidized gaseous effluent is cooled by quenching in water by introducing water through line 41 so as to reduce the temperature to about 200° C. If the gases have an acid character, it is possible to add to the quenching water, through line 42, a base such as soda for example to neutralize these acids.

These cooled gases flow out of treating chamber 40 through line 43 and are contacted with additives such as lime, bicarbonate and/or activated charcoal, through line 44, in order to collect possible metals or other pollutants such as sulfur or chlorine containing products.

The portion of the oxidized gaseous effluent circulating in line 43 is subjected to a filtration stage in filter 45 so as to recover particles formed during the oxidation stage and, if need be, the additives through line 46.

After filtration, the filtered gaseous effluent is discharged through line 47 and sent to chimney 48.

Another portion of the oxidized gaseous effluent from line 34 is fed as gas stream into line 6 to supply lines 3, 4, 5 of contacting zones 11, 12, 13. This recycling advantageously allows to recover the calories released during oxidation of the gaseous effluent in chamber 30.

1. A method intended for continuous depollution of a solid feed essentially comprising earths or sludge, as well as organic pollutants, wherein the following stages are carried out:
a) passing a gas stream brought to a temperature higher than the desorption temperature of water through a solid feed layer arranged in several contacting zones arranged in series, so as to recover a depolluted solid feed and a gaseous effluent comprising pollutants,
b) separating the gaseous effluent comprising pollutants from the depolluted solid feed,
c) sending said gaseous effluent to an oxidation zone so as to oxidize the pollutants and to recover an oxidized gaseous effluent,
d) sending a portion of the oxidized gaseous effluent to a treating unit and introducing another portion of the oxidized gaseous effluent as gas stream in stage a).

2. A method as claimed in claim 1, wherein in stage a), the velocity at which the gas stream is passed through the solid feed layer is lower than the minimum rate of fluidization of said solid feed.

3. A method as claimed in claim 2, wherein the velocity of the gas stream through the solid feed layer is less than 1 m/s, preferably less than 0.5 m/s, more preferably less than 0.25 m/s.

4. A method as claimed in claim 1, wherein the gas stream passed in stage a) has a water content higher than 10% by volume, preferably higher than 15% by weight.

5. A method as claimed in claim 1, wherein stage a) is carried out at a temperature ranging from 500 to 1200° C., preferably from 700 to 1000° C., more preferably from 800 to 900° C.

6. A method as claimed in claim 1, wherein at least a fraction of the gas stream flowing through the solid feed layer has an oxygen content ranging from 2.5 to 15%, preferably from 5 to 10% by volume.

7. A method as claimed in claim 1, wherein a makeup gas stream containing oxygen is introduced during stage a).

8. A method as claimed in claim 7, wherein a makeup gas stream containing oxygen is introduced in the gas stream used in stage a).

9. A method as claimed in claim 7, wherein a makeup gas stream containing oxygen is introduced with the gas stream used in stage a).

10. A method as claimed in claim 7, wherein a makeup gas stream containing oxygen is introduced during stage c).

11. A method as claimed in claim 1, wherein a makeup gas stream containing oxygen is introduced in the oxidation zone for carrying out stage c).

12. A method as claimed in claim 11, wherein a makeup gas stream containing oxygen is introduced in the gaseous effluent of stage b) prior to being fed into the oxidation zone of stage c).

13. A plant intended for continuous depollution of a solid feed, comprising:
at least one hot gas stream supply means (3, 4, 5) and at least one solid feed supply means (1),
a device (2) for contacting the solid feed with the hot gas stream in several contacting zones (11, 12, 13) arranged in series and comprising means (14, 27) for forming a solid feed layer and means (15) allowing the gas stream to be passed through the solid feed layer thus formed,
separation means (20) comprising a depolluted solid feed discharge means (22, 26) and discharge means (23, 25) for a gaseous effluent resulting from passage of the gas stream through the solid feed layer,
an oxidation means (30) comprising precursor means (32, 33) for an oxidation reaction and an oxidized gaseous effluent discharge means (34),
a supply means (35) for a treating unit intended for cleaning the oxidized gaseous effluent and a recycling means (6) connected to the gas stream supply means.

14. A plant as claimed in claim 13, wherein device (2) for contacting the solid feed with the gas stream comprises:
a) a drum (14) provided with orifices (15) and mounted rotating about its longitudinal axis (16), said drum comprising means (17, 18) allowing a feed layer flow to be obtained in said drum, and
b) an enclosure (7) housing drum (14), connected to at least one gas stream supply means (3, 4, 5) and comprising means (8, 9, 10) allowing the gas stream to be passed through said orifices.

15. A plant as claimed in claim 14, wherein the means allowing the gas stream to be passed through the orifices in the lower part of the drum comprise gas stream distribution means (8, 9, 10) allowing to pass distinct fractions of said stream into different contacting zones (11, 12, 13) defined along the longitudinal axis of the drum.

16. A plant as claimed in claim 13, wherein a supply means (53, 54, 55) intended for a makeup gas stream containing oxygen is connected to gas stream supply means (3, 4, 5).

17. A plant as claimed in claim 13, wherein a supply means intended for a makeup gas stream containing oxygen is connected to enclosure (7).

18. A plant as claimed in claim 13, wherein a supply means intended for a makeup gas stream containing oxygen is connected to oxidation means (30).

19. A plant as claimed in claim 13, wherein a supply means intended for a makeup gas stream containing oxygen is connected to discharge means (23, 25) intended for a gaseous effluent resulting from passage of the gas stream through the solid feed layer.
